(19) United States
(12) Patent Application Publication
(10) Pub. No.: US 2005/0277854 A1
(43) Pub. Date: Dec. 15, 2005

(54) Heated fluid, feet massage apparatus

(76) Inventor: Leroy Hatchett, Vallejo, CA (US)

Correspondence Address: S. Michael Bender, P.O. Box 530-399, St. Petersburg, FL, 33747, US

(21) Appl. No.: 11/150,544

(22) Filed: Jun. 10, 2005

Related U.S. Application Data
(60) Provisional application No. 60/579,538, filed on Jun. 14, 2004.

(51) Int. Cl. A61H 9/00

(52) U.S. Cl. 601/15; 601/22; 601/158

(57) ABSTRACT

A feet massage apparatus includes a pair of foot-reception boots. A pair of liquid distribution conduits are connected to the foot-reception boots. A liquid pump is connected to the liquid distribution conduits. A pump-to-reservoir conduit is connected to the liquid pump. A liquid reservoir is connected to the pump-to-reservoir conduit. The liquid reservoir includes a quantity of foot-treating liquid. A pair of air distribution conduits are connected to the foot-reception boots. An air-conduits-to-pump hose is connected to the air distribution conduits, and an air pump is connected to the air-conduits-to-pump hose. The air pump provides air bubbles for bubbling through the foot-treating liquid in the foot-reception boots. To use the apparatus, feet are immersed in a prepared solution that is heated and is agitated by controlled air pumped into the foot-reception boots, thereby providing a soothing massaging action to the feet.

### CROSS-REFERENCE TO RELATED APPLICATION

This application claims priority based upon my copending Provisional Application Ser. No. 60/579,538; filed Jun. 14, 2004.

### BACKGROUND OF THE INVENTION

1. Field of the Invention

The present invention relates generally to hydromassage devices, and, more particularly, to a hydromassage device especially adapted for use on a person's feet.

2. Description of the Prior Art

Devices are well known for massaging various parts of a person's body. Also, devices used for massaging with water (hydromassage) are also well known. In this respect, throughout the years, a number of innovations have been developed relating to massaging devices, and the following U.S. patents are representative of some of those innovations: U.S. Pat. Nos. 4,901,379, 6,632,188, 6,405,390, 6,505,358, and 6,589,194.

More specifically, U.S. Pat. No. 4,901,379 discloses an air excitation hydromassage system for a bathtub. Although a user's feet would be treated if the feet were placed in the specially designed bathtub, excessive quantities of water would be needed if just the feet were to be treated. Moreover, the location of the bathtub is rigidly fixed. Therefore, this device is not portable and cannot be moved to another location if desired. In this respect, it would be desirable if a water and air treatment apparatus for feet were provided that uses relatively small amounts of water and that is easily moved from one location to another.

U.S. Pat. No. 6,632,188 discloses a portable foot massaging apparatus that employs air inflated nodes. With this device, air is used to inflate nodes which serve as small inflated fingers. However, air is not used to provide air bubbles that contact the skin of the user. Since it is well known that the contact of air bubbles with a user's skin can provide desired effects, it would be desirable if a portable foot massaging apparatus were provided which employs air bubbles to contact the skin of the user on the user's feet.

U.S. Pat. No. 6,405,390 discloses a multifunctional foot spa which provides a massaging action on the user's feet using water, mechanical vibrations in the water, and air bubbles. The water can also be heated. Although mechanical vibrations are provided in the water to cause a massaging action, the water in the device does not circulate in the device. However, it is well known that circulating water can provide beneficial effects on a person's body. Therefore, it would be desirable to employ a massaging action on a person's feet that depended upon the circulated flow of water against the users feet.

U.S. Pat. No. 6,505,358 discloses a feet bath apparatus that is similar in form and function to the device discussed above with respect to U.S. Pat. No. 6,405,390.

U.S. Pat. No. 6,589,194 discloses a boot-shaped device which employs a plurality of inflatable sleeves for compressing a person's foot to promoted blood circulation in the foot. No water massage is provided, and no air massage is provided. However, it would be desirable to employ a close fitting boot-shaped device for a person's foot that would provide both water massage and air massage.

Thus, while the foregoing body of prior art indicates it to be well known to use massaging devices for treating a human body, the prior art described above does not teach or suggest a heated fluid, feet massage apparatus which has the following combination of desirable features: (1) uses relatively small amounts of water and is easily moved from one location to another; (2) employs air bubbles to contact the skin of the user on the user's feet; (3) employs a massaging action on a person's feet that depends upon the circulated flow of water against the user's feet; and (4) is a close fitting boot-shaped device for a person's foot that provides both water massage and air massage. The foregoing desired characteristics are provided by the unique heated fluid, feet massage apparatus of the present invention as will be made apparent from the following description thereof. Other advantages of the present invention over the prior art also will be rendered evident.

### SUMMARY OF THE INVENTION

To achieve the foregoing and other advantages, the present invention, briefly described, provides a feet massage apparatus which includes a pair of foot-reception boots. A pair of liquid distribution conduits are connected to the foot-reception boots. A liquid pump is connected to the liquid distribution conduits. A pump-to-reservoir conduit is connected to the liquid pump. A liquid reservoir is connected to the pump-to-reservoir conduit. The liquid reservoir includes a quantity of foot-treating liquid. A pair of air distribution conduits are connected to the foot-reception boots. An air-conduits-to-pump hose is connected to the air distribution conduits, and an air pump is connected to the air-conduits-to-pump hose. The air pump provides air bubbles for bubbling through the foot-treating liquid in the foot-reception boots.

In addition, a valve is located between the pump-to-reservoir conduit and the liquid reservoir. Also, a heating unit is connected to the liquid reservoir for heating liquid in the liquid reservoir. A reservoir cover is provided for covering the liquid reservoir. Preferably, the air distribution conduits are connected to the foot-reception boots at a level above ankle level.

In general, the feet massage apparatus of the invention is designed to provide a therapeutic gentle massage to the foot and to treat foot problems such as those related to sports injuries. In this respect, a foot or feet are immersed in a prepared solution that is heated and is agitated by controlled air pumped into the foot-reception boots. The heated and agitated liquid provides a soothing massaging action to the feet from the toes to a level just above the ankles.

With another embodiment of the invention, a base member is provided for supporting the foot-reception boots, the liquid pump, the liquid reservoir, and the air pump. The base member provides ready transportability to the feet massage apparatus of the invention when the apparatus is fully assembled and operational.

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining at least two preferred embodiments of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

It is therefore an object of the present invention to provide a new and improved heated fluid, feet massage apparatus which has all of the advantages of the prior art and none of the disadvantages.

It is another object of the present invention to provide a new and improved heated fluid, feet massage apparatus which may be easily and efficiently manufactured and marketed.

It is a further object of the present invention to provide a new and improved heated fluid, feet massage apparatus which is of durable and reliable construction.

An even further object of the present invention is to provide a new and improved heated fluid, feet massage apparatus which is susceptible of a low cost of manufacture with regard to both materials and labor, and which accordingly is then susceptible of low prices of sale to the consuming public, thereby making such heated fluid, feet massage apparatus available to the buying public.

Still yet a further object of the present invention is to provide a new and improved heated fluid, feet massage apparatus which uses relatively small amounts of water and is easily moved from one location to another.

Still another object of the present invention is to provide a new and improved heated fluid, feet massage apparatus that employs air bubbles to contact the skin of the user on the user's feet.

Yet another object of the present invention is to provide a new and improved heated fluid, feet massage apparatus which employs a massaging action on a person's feet that depends upon the circulated flow of water against the user's feet.

Even another object of the present invention is to provide a new and improved heated fluid, feet massage apparatus that is a close fitting boot-shaped device for a person's foot that provides both water massage and air massage.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is a front view showing a first embodiment of the heated fluid, feet massage apparatus of the invention, wherein air is bubbled through the feet-reception boots.

FIG. 2 is a top view of the embodiment of the heated fluid, feet massage apparatus shown in FIG. 1 taken along line 2-2 of FIG. 1.

FIG. 3 is a cross-sectional view of the embodiment of the heated fluid, feet massage apparatus of FIG. 1 taken along line 3-3 thereof.

FIG. 4 is a cross-sectional view of the embodiment of the invention shown in FIG. 1 taken along line 4-4 thereof.

FIG. 5 is a front view of a second embodiment of the invention, wherein the components are supported by a common portable base.

FIG. 6 is a top view of the embodiment of the invention shown in FIG. 5, taken along line 6-6 thereof.

### DESCRIPTION OF THE PREFERRED EMBODIMENT

With reference to the drawings, a new and improved heated fluid, feet massage apparatus embodying the principles and concepts of the present invention will be described.

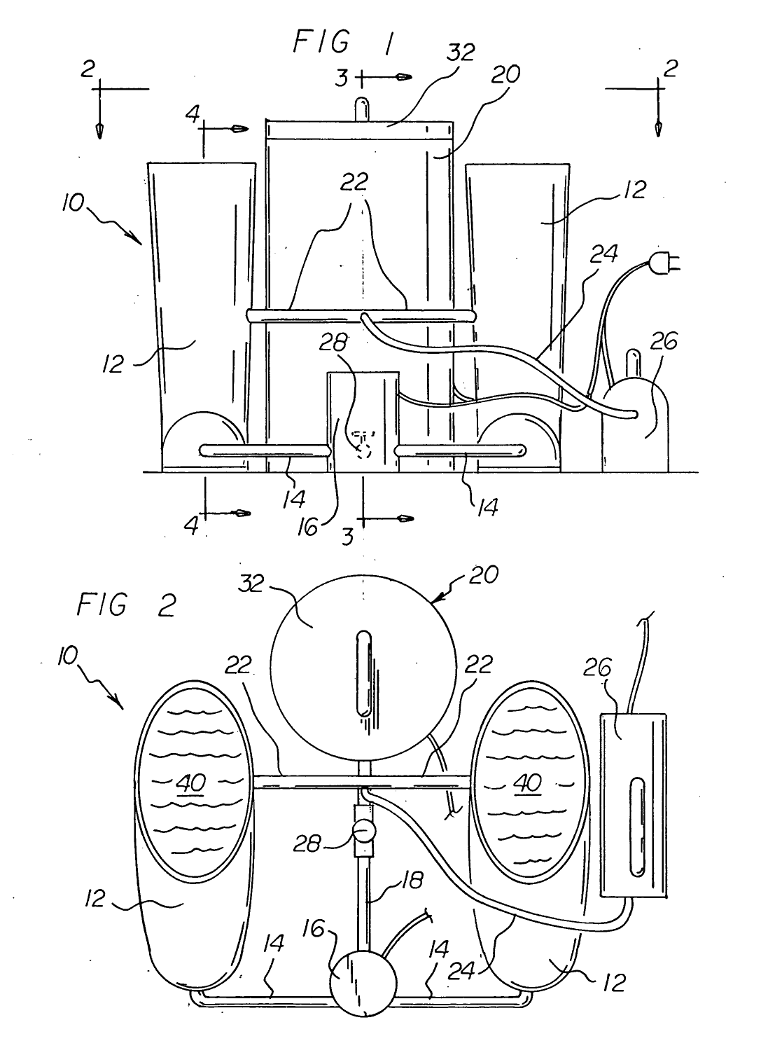

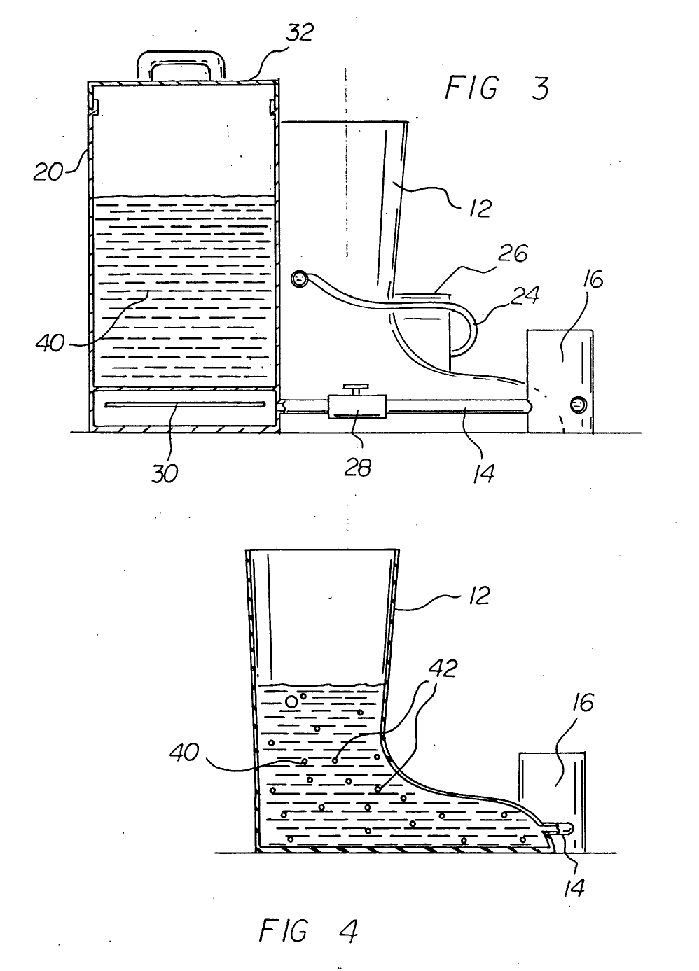

Turning to FIGS. 1-4, there is shown a first embodiment of the heated fluid, feet massage apparatus of the invention generally designated by reference numeral 10. In the first embodiment, the heated fluid, feet massage apparatus 10 includes a pair of foot-reception boots 12. A pair of liquid distribution conduits 14 are connected to the foot-reception boots 12. A liquid pump 16 is connected to the liquid distribution conduits 14. A pump-to-reservoir conduit 18 is connected to the liquid pump 16. A liquid reservoir 20 is connected to the pump-to-reservoir conduit 18. The liquid reservoir 20 includes a quantity of foot-treating liquid 40. A pair of air distribution conduits 22 are connected to the foot-reception boots 12. An air-conduits-to-pump hose 24 is connected to the air distribution conduits 22, and an air pump 26 is connected to the air-conduits-to-pump hose 24. The air pump 26 provides air bubbles 42 for bubbling through the foot-treating liquid 40 in the foot-reception boots 12.

In addition, a valve 28 is located between the pump-to-reservoir conduit 18 and the liquid reservoir 20. Also, a heating unit 30 is connected to the liquid reservoir 20 for heating liquid in the liquid reservoir 20. A reservoir cover 32 is provided for covering the liquid reservoir 20. Preferably, the air distribution conduits 22 are connected to the foot-reception boots 12 at a level above ankle level.

To use the feet massage apparatus 10 of the invention, the reservoir cover 32 is removed from the liquid reservoir 20, and a quantity of foot-treating liquid 40 is placed in the liquid reservoir 20. Then, the reservoir cover 32 is placed back on the liquid reservoir 20. The foot-treating liquid 40 can be heated by the heating unit 30. Some of the foot-treating liquid 40 is allowed to pass from the liquid reservoir 20 into the foot-reception boots 12 through the valve 28 and the liquid pump 16. More specifically, the foot-treating liquid 40 flows through the pump-to-reservoir conduit 18 and the liquid distribution conduits 14 to reach the foot-reception boots 12.

Then, the air pump 26 is turned on, and pumped air passes from the air pump 26, through the air-conduits-to-pump hose 24, through the air distribution conduits 22, and into the foot-reception boots 12 to provide air bubbles 42 in the foot-treating liquid 40, preferably at positions in the foot-reception boots 12 which are above ankle level.

When a foot or both feet of a user are placed in one or two of the foot-reception boots 12, the user's foot or feet are exposed to the massaging action of the heated foot-treating liquid 40 and the air bubbles 42 which are bubbling through the foot-treating liquid 40. In this respect, the user's feet are treated with heat, with air bubbles, and with the foot-treating liquid 40 which can includes water and dissolved foot-treating agents.

Preferably, the liquid pump 16 and the air pump 26 are electrically powered. Also, the heating unit 30 is preferably electrically powered.

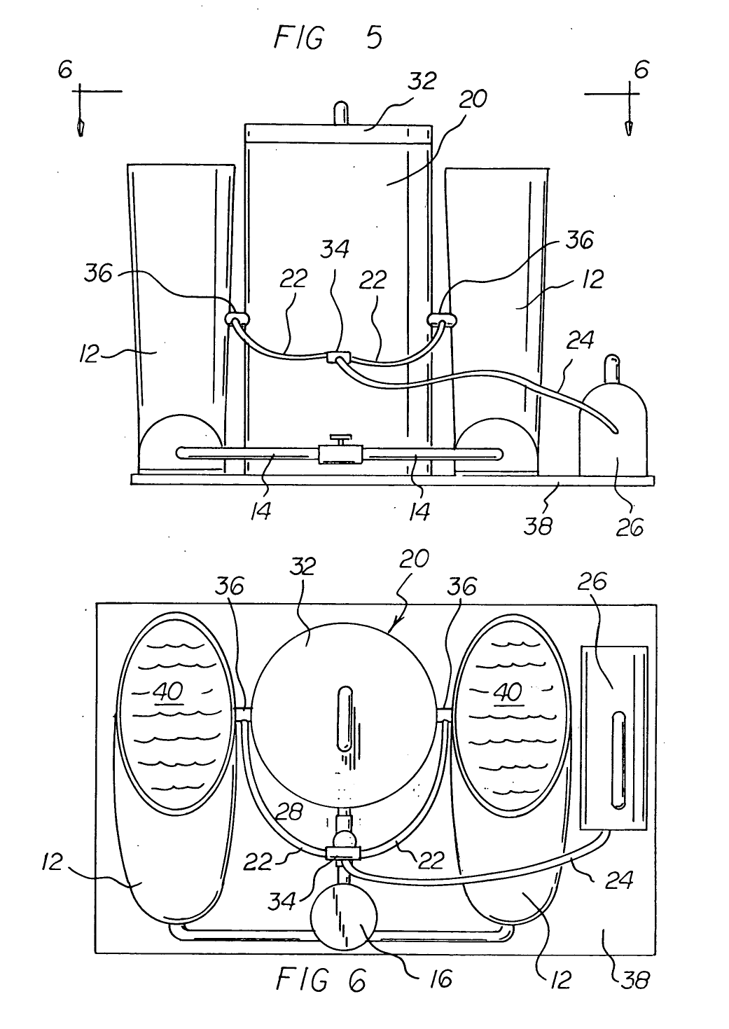

Turning to FIGS. 5 and 6, a second embodiment of the invention is shown. Reference numerals are shown that correspond to like reference numerals that designate like elements shown in the other figures. Also, operation of the second embodiment is substantially the same as the first embodiment with respect to the heated foot-treating liquid 40 and the air bubbles 42 provided to a user's feet placed inside the foot-reception boots 12.

In addition, the second embodiment base member 38 is provided for supporting the foot-reception boots 12, the liquid pump 16, the liquid reservoir 20, and the air pump 26. When the base member 38 is lifted, all of the assembled components on the base member 38 are lifted together. In this respect, the base member 38 provides ready transportability to the feet massage apparatus 10 of the invention when the apparatus is fully assembled and operational.

In addition, reservoir-to-boot spars 36 are connected between the liquid reservoir 20 and the foot-reception boots 12. The reservoir-to-boot spars 36 provide structural stability to the fully assembled apparatus and help keep the components of the apparatus from shifting or moving when the apparatus is transported.

The foot-treating liquid 40 can be a specially prepared foot-treating solution. In this respect, the foot-treating solution can include water, dissolved epsom salt, rubbing alcohol, dissolved borax, and hexal, among other ingredients.

In general, the feet massage apparatus 10 of the invention is designed to provide a therapeutic gentle massage to the foot and to treat foot problems such as those related to sports injuries. As stated above, a foot or feet are immersed in a prepared solution 40 that is heated and is agitated by controlled air pumped into the foot-reception boots 12. The heated and agitated liquid 40 provides a soothing massaging action to the feet from the toes to a level just above the ankles.

The components of the heated fluid, feet massage apparatus of the invention can be made from inexpensive and durable metal and plastic materials.

As to the manner of usage and operation of the instant invention, the same is apparent from the above disclosure, and accordingly, no further discussion relative to the manner of usage and operation need be provided.

It is apparent from the above that the present invention accomplishes all of the objects set forth by providing a new and improved heated fluid, feet massage apparatus that is low in cost, relatively simple in design and operation, and which advantageously uses relatively small amounts of water and is easily moved from one location to another. With the invention, a heated fluid, feet massage apparatus is provided which employs air bubbles to contact the skin of the user on the user's feet. With the invention, a heated fluid, feet massage apparatus is provided which employs a massaging action on a person's feet that depends upon the circulated flow of water against the user's feet. With the invention, a heated fluid, feet massage apparatus is provided which is a close fitting boot-shaped device for a person's foot that provides both water massage and air massage.

Thus, while the present invention has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use.

Hence, the proper scope of the present invention should be determined only by the broadest interpretation of the appended claims so as to encompass all such modifications as well as all relationships equivalent to those illustrated in the drawings and described in the specification.

Finally, it will be appreciated that the purpose of the annexed Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

1. A feet massage apparatus, comprising:
a pair of foot-reception boots,
a pair of liquid distribution conduits connected to said foot-reception boots,
a liquid pump connected to said liquid distribution conduits,
a pump-to-reservoir conduit connected to said liquid pump,
a liquid reservoir connected to said pump-to-reservoir conduit, wherein said liquid reservoir includes a quantity of foot-treating liquid,
a pair of air distribution conduits connected to said foot-reception boots,
an air-conduits-to-pump hose connected to said air distribution conduits, and
an air pump connected to said air-conduits-to-pump hose, wherein said air pump provides air bubbles for bubbling through said foot-treating liquid in said foot-reception boots.

2. The apparatus of claim 1, further including:
a valve located between said pump-to-reservoir conduit and said liquid reservoir.

3. The apparatus of claim 1, further including:
a heating unit connected to said liquid reservoir for heating liquid in said liquid reservoir.

4. The apparatus of claim 1, further including:
a reservoir cover for covering said liquid reservoir.

5. The apparatus of claim 1 wherein said air distribution conduits are connected to said foot-reception boots at a level above ankle level.

6. The apparatus of claim 1, further including:
a base member for supporting said foot-reception boots, said liquid pump, said liquid reservoir, and said air pump.

7. The apparatus of claim 1, further including:
reservoir-to-boot spars connected between said liquid reservoir and said foot-reception boots.
